(19) United States
(12) Patent Application Publication
(10) Pub. No.: US 2008/0224375 A1
(43) Pub. Date: Sep. 18, 2008

(54) Clamp Arrangement

(76) Inventors: Simon Mills, Llanfyllin (GB); Paul Jenkins, Llanidloes (GB)

Correspondence Address: GORDON & JACOBSON, P.C., 60 LONG RIDGE ROAD, SUITE 407, STAMFORD, CT, 06902, US

(21) Appl. No.: 11/738,546

(22) Filed: Apr. 23, 2007

(30) Foreign Application Priority Data
Mar. 16, 2007 (GB) 0705055.2

(51) Int. Cl. B23Q 3/06

(52) U.S. Cl. 269/134; 269/140

(57) ABSTRACT

A clamp has a first jaw and a second jaw mounted to be movable with respect to one another between a clamping configuration and a release configuration. A catch mechanism has a movable detent operable to engage with a locking element in a plurality of different positions dependent upon the degree of separation of the jaws. A tightening mechanism is manually operable to tighten the jaws by providing a tightening force acting via the catch mechanism.

### FIELD OF THE INVENTION

The present invention comprises a clamp arrangement and in particular such an arrangement for use as a hand tool.

### BACKGROUND TO THE INVENTION

A variety of clamp arrangements are known which purport to provide provision of an ability to clamp securely and tightly over a wide range of clamping widths. Some have the ability to permit initial coarse adjustment of the jaws to an approximate target separation distance and enable subsequent tightening of the jaws about the item(s) to be clamped.

### SUMMARY OF THE INVENTION

According to a first aspect the present invention provides a clamp arrangement comprising:

a first jaw and a second jaw mounted to be movable with respect to one another between a clamping configuration and a release configuration;

a catch mechanism comprising a movable detent operable to engage with a locking element in a plurality of different positions dependent upon the degree of separation of the jaws;

a tightening means operable to tighten the jaws by providing a tightening force acting via the catch mechanism.

It is preferred that one or both of the first and second jaws are pivotably movable. The arrangement may comprise an effectively fixed jaw and a movable jaw pivotally mounted with respect to the effectively fixed jaw.

Beneficially resilient biassing arrangement is provided to bias the jaws together. This preferably comprises a resilient biassing arrangement which acts to inhibit opening of the jaws beyond a predetermined extent, and acts to close the jaws if opened beyond the predetermined extent. A spring or elastically extendible tether may be provided for this purpose.

It is preferred that the arrangement includes a biassing arrangement to bias the detent into engagement with the locking element. The detent biassing arrangement may comprise a spring such as a leaf spring.

The detent is preferably manually actuatable to act against a biassing force to be moved, selectively, out of engagement with the locking element. The biassing force tends to urge the detent back into contact with the locking element.

The locking element preferably includes a plurality of spaced engagement formations, the detent engaging with different engagement formations dependent upon the degree of separation of the jaws. These engagement formations are beneficially in the form of teeth or serrations, preferably extending in a series along an edge (beneficially an arcing edge) of the locking element.

Preferably, the detent is pivotably movable into and out of engagement with the locking element. The detent is preferably mounted to one of the jaws.

Advantageously, the tightening arrangement acts to pivot the locking element to transmit a closing force via the detent to tighten the jaws. In an embodiment which may be preferred for certain uses, the tightening arrangement may comprise a screw threaded shaft, the locking element being matingly connected to the screw threaded shaft via a threaded bore connector. In certain embodiments, the tightening mechanism comprises an elongate handle which is rotated to effect tightening and release. In other embodiments tightening may be effected by a cam and follower arrangement or an expanding/contracting linkage (such as a scissors linkage).

In certain embodiments, it is preferred that one or both of the jaws have pivotable grip elements mounted to the end of the respective jaws. This may enable secure gripping during clamping of differently shaped items.

According to a second aspect, the present invention provides a clamp arrangement comprising:

a first jaw;

a second jaw pivotably mounted with respect to the first jaw;

a first closure system providing a first closing bias to close the jaws; and

a second closure system providing a second closing bias to close the jaws.

The first closure system preferably acts to locate the jaws to a relatively loosely clamped position and the second closure system acts to clamp the jaws more tightly from the relatively loosely clamped position.

Beneficially, this may for example comprise a resilient biassing arrangement which acts to inhibit opening of the jaws beyond a predetermined extent, and acts to close the jaws if opened beyond the predetermined extent. A spring or elastically extendible tether may be provided for this purpose. the first closure system comprises a resilient biassing element between the jaws.

It is preferred that the second closure system comprises a manually actuatable tightening mechanism.

Desirably, in this aspect of the invention the arrangement includes a catch mechanism comprising a movable detent operable to engage with a locking element in a plurality of different positions dependent upon the degree of separation of the jaws; and a tightening arrangement operable to tighten the jaws by providing a tightening force acting via the catch mechanism.

Preferred features of the second aspect of the invention may correspond to preferred features of the first defined aspect of the invention.

### DESCRIPTION OF THE PREFERRED EMBODIMENTS

The invention will now be further described in specific embodiments, by way of example only, and with reference to the accompanying drawings.

### BRIEF DESCRIPTION OF THE DRAWINGS

FIG. 1 is a schematic view of a clamp arrangement in accordance with the invention;

FIG. 2 is a schematic view of an alternative configuration of a clamp in accordance with the invention;

FIG. 3 is a schematic view of a further alternative clamp arrangement configuration in accordance with the invention;

FIG. 4 is a schematic view of a further alternative configuration, and;

FIG. 5 is a schematic view of a yet further embodiment in accordance with the invention;

FIG. 6 is a schematic view of a further alternative embodiment in accordance with the invention;

FIG. 7 is a schematic view of a yet further alternative embodiment in accordance with the invention.

### DETAILED DESCRIPTION OF THE PREFERRED EMBODIMENTS

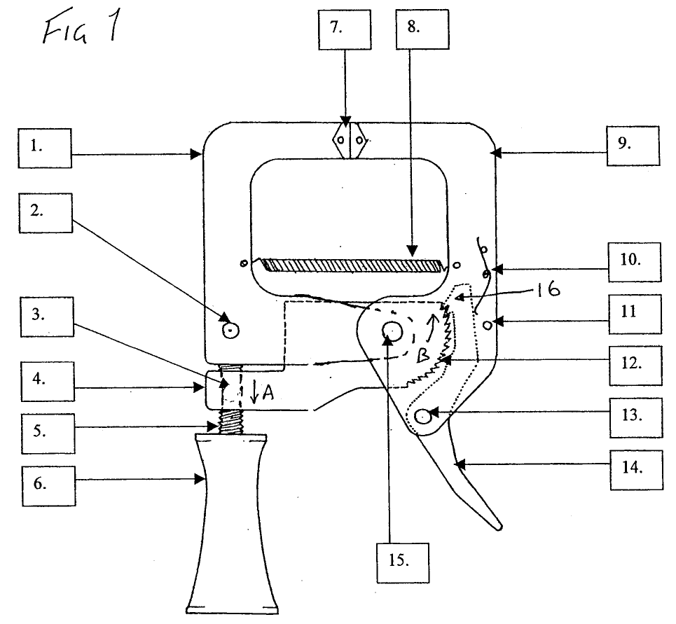

Referring to the drawings, and initially primarily to FIG. 1, there is shown a clamp arrangement comprising a first, effectively fixed, jaw (1), and a second pivotal jaw (9). Jaw (9) is mounted pivotally with respect to the fixed jaw (1) by means of pivot pin (15). The jaws open to separate respective pivotally mounted clamp anvils (7). Extending between the jaws (1) and (9) is a resilient spring tether (8) providing a first closure means for the arrangement. The spring tether (8) acts to close the jaws (1) (9) when they are pulled apart from a closed configuration as shown in FIG. 1.

A handle (6) is connected to fixed jaw (1) by means of a screw threaded shaft (5) and a pivot connection (2). A locking plate (4) is mounted to threaded shaft (5) by means of a correspondingly threaded bore (3). Rotation of the threaded handle (6) about its longitudinal axis causes corresponding rotation of the threaded shaft (5), which enables the shaft of locking plate (4) to move longitudinally up along the threaded shaft (5) depending upon the direction of rotation. The end of locking plate (4) distal from the threaded bore (3) is provided with an arc-form serrated tooth edge (12). Locking plate (4) is mounted to be pivotable about pivot pin (15).

A detent lever (14) is mounted via a pivot (13) to the pivotable jaw (9). The proximal end of detent lever (14) is arranged to be gripped by the fingers of a user and extends downwardly and outwardly from the jaw (9). The distal end of detent lever (14) is provided with an engagement formation (16) which has corresponding teeth arranged to engage with the serrated tooth edge (12) of the locking plate (4). A leaf spring (10) is arranged to normally bias the distal end of detent lever (14) into meshed engagement with the serrated tooth arc-form edge of locking plate (4). A stop pin (11) is provided to limit the outward pivotal movement of the distal end of detent lever (14).

The engagement formation (16) of the lever (14) and serrated tooth edge (12) provide the catch mechanism of the invention. Other realisations of suitable catch mechanism are envisaged such as for example disengageable clutch or brake arrangements.

In use, in order to open the jaws of the clamp, the user grips the handle (6) and pulls the proximal end of lever (14) towards the handle (6) by means of the fingers. This causes the detent lever (14) to pivot about pivot pin (13) and the distal teeth (16) to disengage from engagement with the serrated tooth arc-form edge of the locking plate (4). The distal end (16) of lever (14) engages the stop pin (11) and thereafter drawing the proximal end of lever (14) toward the handle (6) causes continued opening of the jaws of the clamp arrangement.

Having been opened, the jaw can then be closed upon the items to be clamped. This is done by releasing the grip between handle (6) and detent lever (14) allowing the jaws to close under the influence of the resilient spring tether (8). The clamp anvils (7) abut the item to be clamped and the teeth (16) at the distal end of detent lever (14) re-engage with the serrated tooth arc-form edge of the locking plate (4) at a position along the arc-from edge dependent upon the size of the item being clamped. For larger items clamped, the position of engagement will be toward the lower point of the serrated arc-form edge. For smaller items the position of engagement will be toward the upper point of the serrated arc-form edge (approximating the clamp closed position as shown in FIG. 1). The detent leaf spring (10) biases the distal end of the detent lever (14).

This closure system provides a first closure action by means, effectively, of a quick release of the clamp, the engagement (clamping) force being provided via the resilient spring tether (8). This only provides a relatively weak clamping force. The maximum tightening force is provided by means of actuating the handle (6) by rotating it about its axis in a tightening direction, causing rotation of the screw threaded shaft (5) and movement in a downward direction (arrow A in FIG. 1) of the threaded bore (3) of the locking plate (4). This causes pivoting of the locking plate about pivot pin (15) and the arc-from serrated tooth edge of the locking plate (4) to pivot upwardly as shown by arrow B in FIG. 1. This provides a force acting on the distal end (16) of detent lever (14) in an upward direction and therefore, via the pivot connection (13), the jaw (9) to be pivoted upwardly about pivot pin (15) enhancing and increasing the jaw closing force. Effectively therefore, the closing force is transmitted from the turning of the handle (6) via the locking plate (4) to the detent lever (14) and onto the jaw (9) in order to close the jaw.

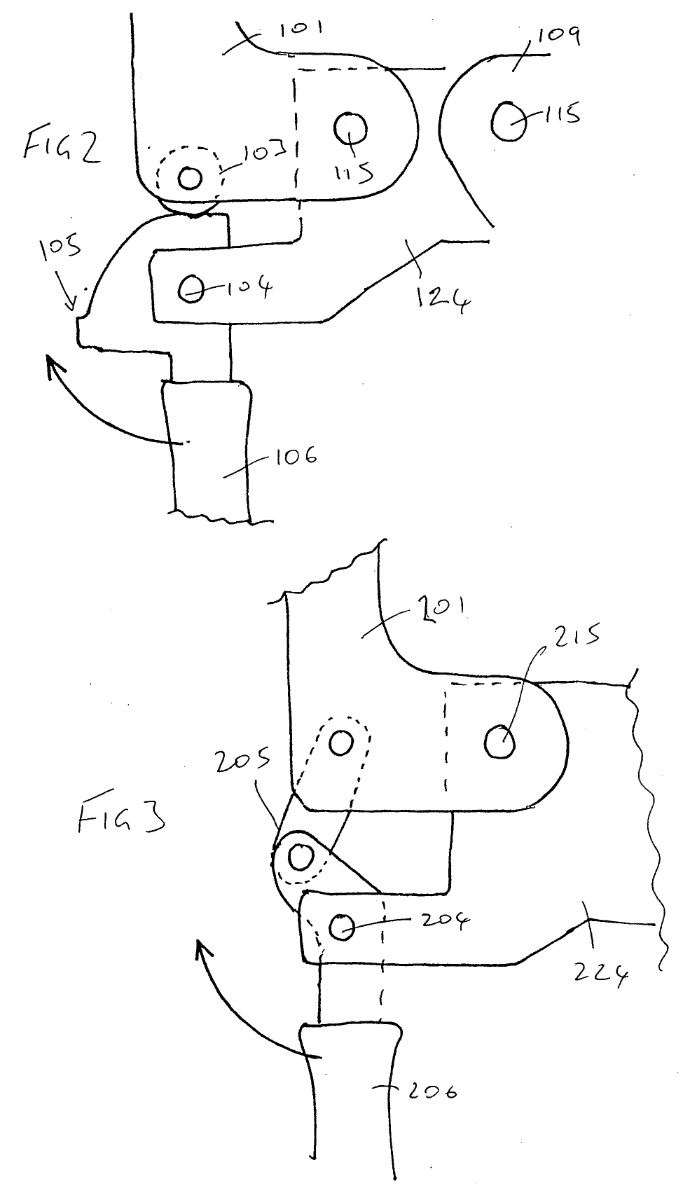

Referring now to FIG. 2, there is shown an alternative embodiment in which both jaws (101 and 109) are pivotable about respective pivots (115) and in this instance the second, tightening force is applied via handle (106) by means of a cam formation (105) which, when lever (106) is pivoted about a pivot pin (104) to a maximum extent urges, via cam follower (103), the jaw (101) to pivot, in closing fashion, about pivot pin (115).

A further alternative or embodiment is shown in FIG. 3 in which the jaw (201) is caused to pivot about pivot pin (215) by means of the lever actuation of handle (206) (in the direction shown by the arrow in FIG. 3). Such operation of the handle (206) causes a toggle linkage mechanism (205) to open and close the jaws. In the embodiment shown, movement of the lever (206) about pivot (204) in the direction of the arrow causes the jaws to close.

In both embodiments of FIG. 2, closing forces applied by the handle by means of pivoting of the locking plate (124, 224) to the detent lever (not shown and unto the respective other jaw (109, 209)). Additionally, in a similar fashion to the embodiment of FIG. 1, the embodiments of FIGS. 2 and 3 could replace separate pivots (115, 215) for each jaw with an effectively fixed jaw and a single pivoted jaw about a single pivot point as shown in FIG. 1.

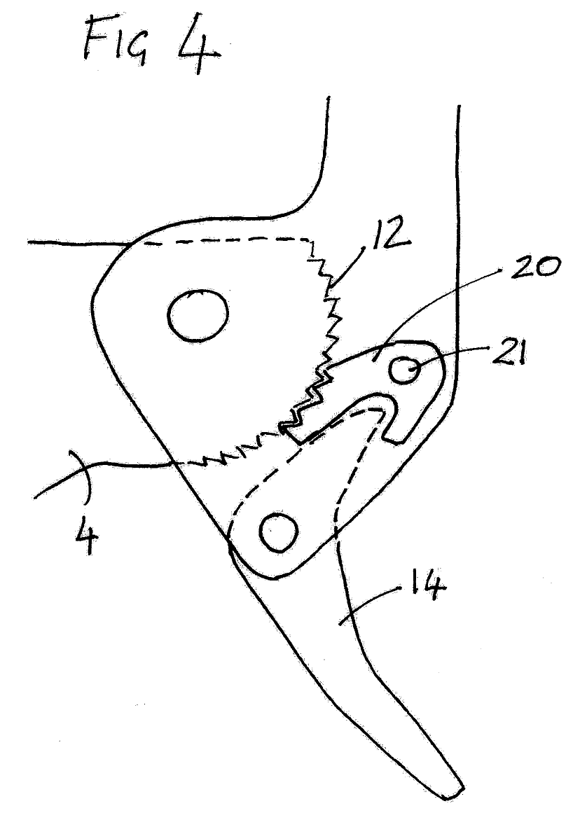

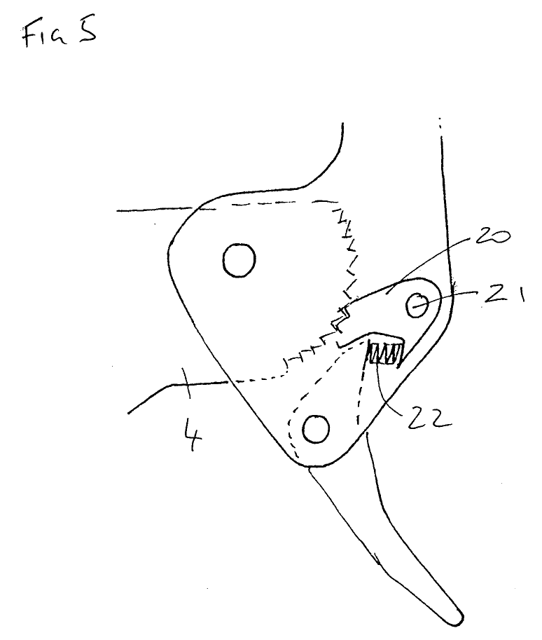

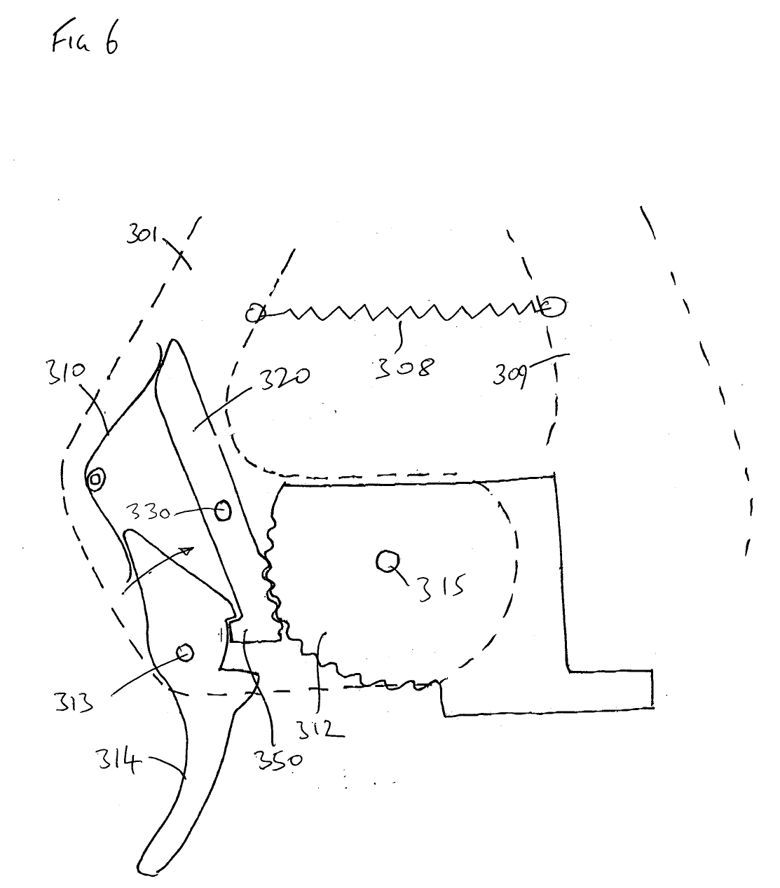

FIGS. 4 and 5 show alternative means of connecting the detent lever (14) to the arc-form serrated tooth edge (12) of the locking plate 4. In both embodiments a separate pawl lever (20) is provided, pivoted about a respective pivot pin (21).

In the embodiment shown in FIG. 4, the distal end of lever (14) engages in a slot formation of the pawl (20) such that actuation of the lever (14) by pulling towards the handle (12) causes the pawl (20) to pivot out of engagement with the serrated teeth (12).

The embodiment of FIG. 5 operates in a similar manner, however in this instance the lever (14) operates the pawl (20) via a spring (22) (or other compressible element) to prevent the detent lever releasing the jaws when the clamp is applying maximum pressure.

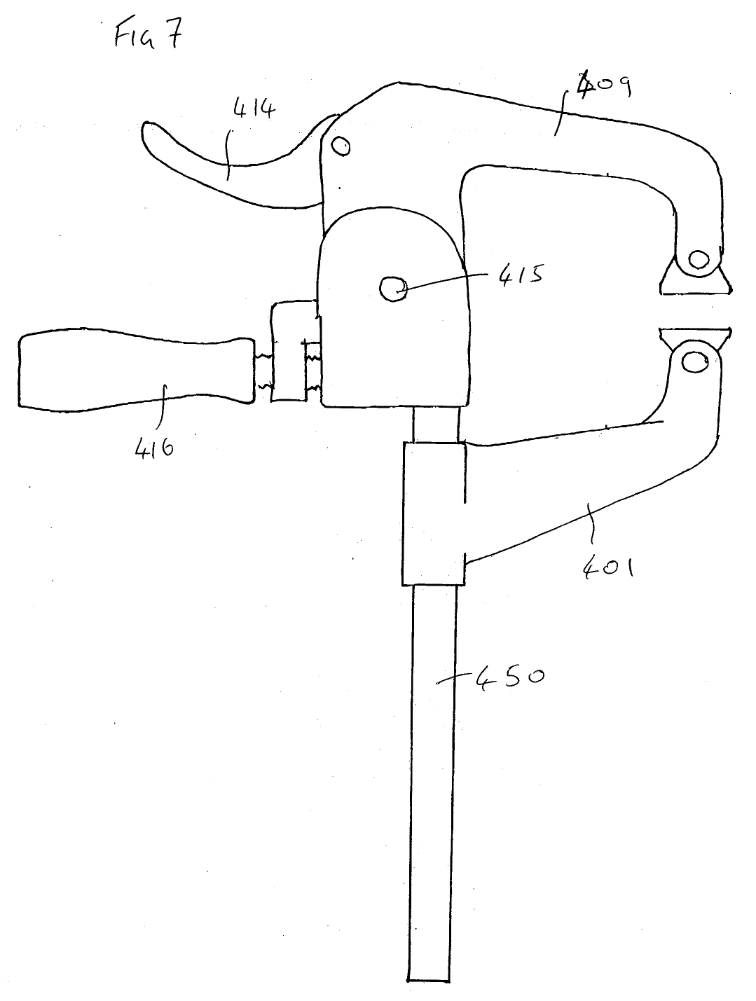

In the embodiment of FIG. 6 a pawl lever (320) is pivoted on a pivot (330) which is fixed with respect to jaw (301). When the jaws (301, 309) are pulled apart as the clamp opens, the pawl teeth of lever (320) tend to disengage with the serrated tooth arc form edge (312) as the pivot post (320) moves away from the jaw (309). The trigger lever (314) is biassed by leaf spring (310) into engagement with the pawl lever tending to normally urge the pawl lever (320) into engagement with the serrated tooth arc form edge (312). The leaf spring also acts directly on the distal end of the pawl lever (320). The point of contact between the anvil (350) of the pawl lever (320) and the trigger lever is at a cam surface and arranged such that there is little or no turning moment generated about the pivot point (313) of the trigger lever (314). As a result the pawl lever (320) cannot cause the trigger lever (314) to rotate. In effect the trigger lever (314) locks the jaw (301) to the serrated tooth arc form edge (312) until the trigger lever (314) is moved to draw the jaw (301) away from the jaw (309).

In the embodiment of FIG. 7 the arrangement is generally similar to the arrangement of FIG. 1 but the fixed jaw (401) is mounted to be slideable along an elongate arm (450). The position of the jaw (401) on the arm (450) may be adjustable secured with a locking screw or other fixing, in certain embodiments. Jaw (409) pivots about pivot (415) in response to clamp opening actuation of the trigger lever (414). The handle (416) is rotated to apply the jaw tightening force via the catch mechanism about the item (or items) to be clamped.

The invention as described provides a robust clamp arrangement in which a first closure means (resilient spring tether (8)) can be used for initial closing of the jaws in a quick, secure fashion about an item to be clamped. Subsequently, maximum clamping force may be applied via the tightening arrangement (rotatable handle (6) or other actuator handle), providing a second closure system to tighten the jaws to a maximum degree.

1. A clamp arrangement comprising:
a first jaw and a second jaw mounted to be movable with respect to one another between a clamping configuration and a release configuration;
a catch mechanism comprising a movable detent operable to engage with a locking element in a plurality of different positions dependent upon the degree of separation of the jaws;
a tightening arrangement operable to tighten the jaws by providing a tightening force acting via the catch mechanism.

2. A clamp arrangement according to claim 1 wherein one or both of the first and second jaws are pivotably movable.

3. A clamp arrangement according to claim 1, wherein a resilient biassing arrangement is provided to bias the jaws together.

4. A clamp arrangement according to claim 1, wherein the clamp arrangement includes a biassing element to bias the detent into engagement with the locking element.

5. A clamp arrangement according to claim 1, wherein the detent is manually actuatable to act against a biassing force to be moved, selectively, out of engagement with the locking element.

6. A clamp arrangement according to claim 1, wherein the locking element includes a plurality of spaced engagement formations, the detent engaging with different engagement formations dependent upon the degree of separation of the jaws.

7. A clamp arrangement according to claim 1, wherein the detent is pivotably movable into and out of engagement with the locking element.

8. A clamp arrangement according to claim 1, wherein the detent is mounted to one of the jaws.

9. A clamp arrangement according to claim 1, wherein the tightening arrangement acts to pivot the locking element to transmit a closing force via the detent to tighten the jaws.

10. A clamp arrangement according to claim 1, wherein the tightening arrangement comprises a screw threaded shaft, the locking element being matingly connected to the screw threaded shaft via a threaded bore connector.

11. A clamp arrangement according to claim 1, wherein the tightening mechanism comprises an elongate handle which is rotated to effect tightening and release.

12. A clamp arrangement according to claim 1, wherein one or both of the jaws have pivotable grip elements mounted to the end of the respective jaws.

13. A clamp arrangement according to claim 1 wherein one of the jaws is mounted on an elongate arm to be movable with respect to the other of the jaws.

14. A clamp arrangement according to claim 13, wherein the arm mounted jaw is slidable along the arm.

15. A clamp according to claim 13, wherein the arm mounted jaw includes a securing mechanism to secure the jaw at a desired position along the arm.

16. A clamp arrangement comprising:
a first jaw;
a second jaw pivotably mounted with respect to the first jaw;
a first closure system providing a first closing bias to close the jaws; and
a second closure system providing a second closing bias to close the jaws.

17. A clamp arrangement according to claim 16, wherein the first closure system acts to locate the jaws to a relatively loosely clamped position and the second closure system acts to clamp the jaws more tightly from the relatively loosely clamped position.

18. A clamp arrangement according to claim 16, wherein the first closure system comprises a resilient biasing element between the jaws.

19. A clamp arrangement according to claim 16, wherein the second closure system comprises a manually actuable tightening mechanism.

20. A clamp arrangement according to claim 16, wherein the arrangement includes a catch mechanism comprising a movable detent operable to engage with a locking element in a plurality of different positions dependent upon the degree of separation of the jaws; and a tightening arrangement operable to tighten the jaws by providing a tightening force acting via the catch mechanism.
